(19) United States
(12) Patent Application Publication
(10) Pub. No.: US 2019/0191091 A1
(43) Pub. Date: Jun. 20, 2019

(54) IMAGE CAPTURING APPARATUS, CONTROL METHOD THEREOF, AND NON-TRANSITORY COMPUTER-READABLE STORAGE MEDIUM

(71) Applicant: CANON KABUSHIKI KAISHA, Tokyo (JP)

(72) Inventor: Atsuya Kawanishi, Kawasaki-shi (JP)

(21) Appl. No.: 16/218,617

(22) Filed: Dec. 13, 2018

(30) Foreign Application Priority Data
Dec. 18, 2017 (JP) 2017-242230

(51) Int. Cl. H04N 5/232; G02B 7/36; G03B 13/36

(52) U.S. Cl. CPC H04N 5/23287; H04N 5/23212; G03B 13/36; G02B 7/36; H04N 5/23296

(57) ABSTRACT

An image capturing apparatus includes an image sensor, a determination unit configured to determine an in-focus direction, a control unit configured to perform focus adjustment by moving a wobbling center position of the focus lens, and an acquisition unit configured to acquire a first focus signal obtained from a first focus detection area and a second focus signal obtained from a second focus detection area including the first focus detection area, wherein the control unit judges a final in-focus direction based on a first in-focus direction if a first moving direction matches the first in-focus direction, and judges the final in-focus direction based on the first in-focus direction and a second in-focus direction if the first moving direction does not match the first in-focus direction.

### BACKGROUND OF THE INVENTION

### Field of the Invention

The present invention relates to a focus adjustment technique in an image capturing apparatus.

### Description of the Related Art

In conventional automatic focusing (AF) of a contrast detection method, since it is difficult to satisfy both responsiveness (trackability) and stability (quality), design is generally performed such that the latter has an importance for moving image shooting which requires natural focusing. On the other hand, in recent years, since automatic focusing of a phase difference detection method at an image capturing plane is employed, it is relatively easy to satisfy both responsiveness (trackability) and stability (quality). Accordingly, smooth tracking has been required for a moving object even in moving image shooting.

Although the use of the above image capturing plane phase difference detection method allows automatic focusing satisfying both the responsiveness and the stability, the contrast detection method may have a better focusing accuracy than the image capturing plane phase difference detection method depending on objects and situations. In addition, in the image capturing plane phase difference detection method, a plurality of readout operations must be performed to obtain image signals having phase differences from the pixels. A high-speed readout operation of the pixel signals is required. For this reason, the responsiveness and the stability must be satisfied not only in automatic focusing of the image capturing plane phase difference detection method but also in automatic focusing of the contrast detection method.

However, a moving object has no predetermined position with respect to a focus detection frame, and the contrast component of the object may fall outside the focus detection frame depending on the composition. For this reason, it is difficult to stably detect a change in contrast. An in-focus direction cannot be accurately determined during a wobbling operation, thereby degrading the focusing accuracy.

Japanese Patent Laid-Open No. 2016-197215 discloses a technique for performing stable AF control for objects having different distances within a focus detection frame.

However, the conventional technique disclosed in Japanese Patent Laid-Open No. 2016-197215 aims at stabilizing the focus when objects having different distances are mixed in the focus detection frame. No description is made for a wobbling operation control method. For this reason, it is impossible to perform smooth focal point tracking with respect to a moving object.

A wobbling operation as general moving image AF control in automatic focusing of the contrast detection method will be described with reference to FIGS. 7A and 7B. The wobbling operation is an operation for continuously vibrating a focus lens in an optical axis direction and moving a vibration center position in a direction of increasing a focus signal while confirming the magnitude relationship between the vibration destination near/infinity side focus signals.

In an example shown in FIG. 7A, the focus lens is sequentially vibrated like I from the AF start position with respect to the stationary object, and the vibration center position is moved in a direction of increasing the focus signal. Accordingly, the in-focus direction can be determined without large out of focus. The operation smoothly shifts to a hill climbing operation II. After that, if a position where the focus signal is maximum is found, the position of the focus lens is returned to near the in-focus position by a peak return operation III. The wobbling operation like IV is performed again to determine a final in-focus position.

On the other hand, if an object is moving, a focus signal may be unstable for each frame, as shown in FIG. 7B. For this reason, the wobbling operation I responds to the change in focus signal and accidentally shifts to the hill climbing operation II, so that the focus becomes unstable.

### SUMMARY OF THE INVENTION

The present invention has been made in consideration of the above problem and provides an image capturing apparatus capable of performing automatic focusing satisfying both responsiveness and stability even if automatic focusing of a contrast detection method is used.

According to a first aspect of the present invention, there is provided an image capturing apparatus comprising: an image sensor configured to capture an object image; a determination unit configured to determine an in-focus direction as a direction of moving a focus lens to focus on the object image based on a magnitude relationship between focus signals obtained from the image sensor when the focus lens for adjusting a focal point undergoes wobbling along an optical axis; a control unit configured to perform focus adjustment by moving a wobbling center position of the focus lens in the in-focus direction; and an acquisition unit configured to acquire a first focus signal serving as the focus signal obtained from a first focus detection area of the image sensor and a second focus signal serving as the focus signal obtained from a second focus detection area including the first focus detection area and larger than the first focus detection area, wherein the control unit judges a final in-focus direction based on a first in-focus direction if a first moving direction serving as a direction of moving the current wobbling center position of the focus lens matches the first in-focus direction serving as the in-focus direction determined by the determination unit based on the first focus signal, and judges the final in-focus direction based on the first in-focus direction and a second in-focus direction serving as the in-focus direction determined by the determination unit based on the second in-focus signal if the first moving direction does not match the first in-focus direction.

According to a second aspect of the present invention, there is provided a method of controlling an image capturing apparatus including an image sensor configured to capture an object image, the method comprising: determining an in-focus direction as a direction of moving a focus lens to focus on the object image based on a magnitude relationship between focus signals obtained from the image sensor when the focus lens for adjusting a focal point undergoes wobbling along an optical axis; controlling to perform focus adjustment by moving a wobbling center position of the focus lens in the in-focus direction; and acquiring a first focus signal serving as the focus signal obtained from a first focus detection area of the image sensor and a second focus signal serving as the focus signal obtained from a second focus detection area including the first focus detection area and larger than the first focus detection area, wherein in the controlling, a final in-focus direction is judged based on a first in-focus direction if a first moving direction serving as a direction of moving the current wobbling center position of the focus lens matches the first in-focus direction serving as the determined in-focus direction based on the first focus signal, and the final in-focus direction is judged based on the first in-focus direction and a second in-focus direction serving as the in-focus direction determined by the determination unit based on the second in-focus signal if the first moving direction does not match the first in-focus direction.

Further features of the present invention will become apparent from the following description of exemplary embodiments with reference to the attached drawings.

### BRIEF DESCRIPTION OF THE DRAWINGS

FIG. 1 is a block diagram showing the arrangement of a digital camera as the first embodiment of an image capturing apparatus of the present invention;

FIGS. 2A and 2B are flowcharts showing the overall sequence of AF control in a moving image;

FIGS. 3A and 3B are views showing the layout of a focus detection frame according to the first embodiment;

FIGS. 4A to 4D are flowcharts showing a wobbling operation sequence according to the first embodiment;

FIG. 5 is a chart showing the movement of a focus lens in the wobbling operation;

FIGS. 6A to 6D are flowcharts showing a wobbling operation sequence according to the second embodiment; and

FIGS. 7A and 7B are views showing the problem of a related art.

### DESCRIPTION OF THE EMBODIMENTS

The embodiments of the present invention will now be described in detail with reference to the accompanying drawings.

### First Embodiment

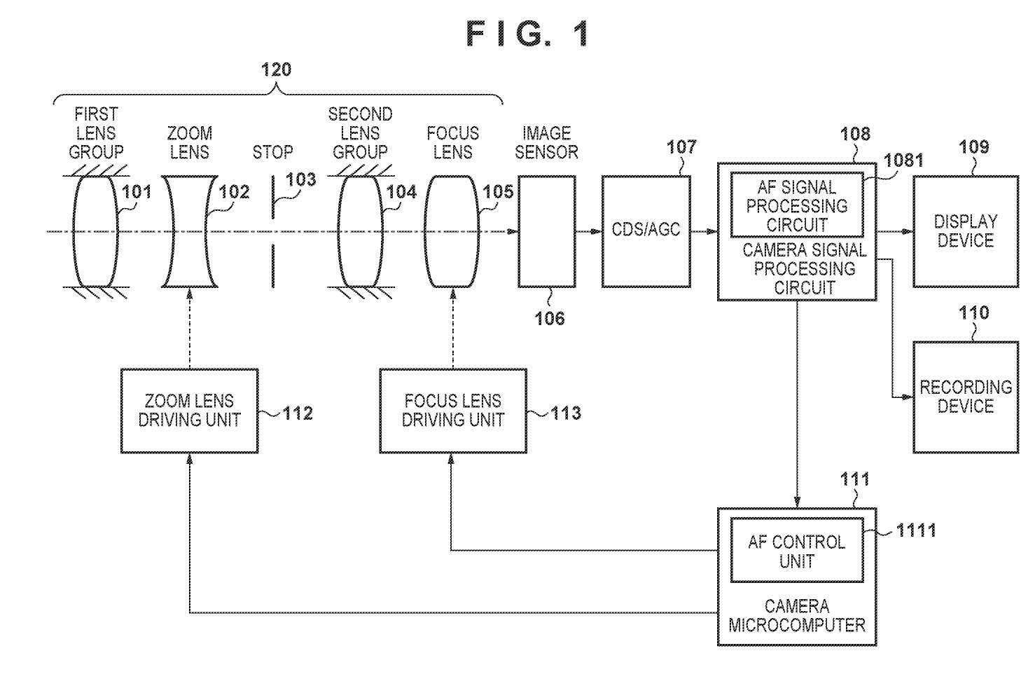

FIG. 1 is a block diagram showing the arrangement of a digital camera 100 as the first embodiment of an image capturing apparatus of the present invention. Referring to FIG. 1, light from an object passes through a shooting optical system 120 and is focused on an image sensor 106 as an object image. A fixed first lens group 101, a zoom lens 102 moved in an optical axis direction to perform scaling, a stop 103 which adjusts a light amount, a fixed second lens group 104 are arranged in the shooting optical system 120 in an order from the object side. A focus lens 105 having a function of correcting an image plane variation upon scaling and a focus function is also arranged in the shooting optical system 120. Note that in FIG. 1, although each lens group is formed from a single lens, each lens group may be actually formed from a single lens or a plurality of lenses.

The image sensor 106 is a photoelectric conversion element formed from a CCD or CMOS sensor. The image sensor 106 photoelectrically converts an object image and outputs an analog signal. Note that the image sensor 106 may be arranged for each of three primary colors of red (R), green (G), and blue (B). A CDS/AGC/AD converter 107 samples the analog output from the image sensor 106, performs gain adjustment, and converts the analog signal into a digital signal. A camera signal processing circuit 108 performs various kinds of image processing on the output signal from the CDS/AGC/AD converter 107 to generate an image signal.

An AF (Automatic Focus) signal processing circuit 1081 is arranged in the camera signal processing circuit 108. The AF signal processing circuit 1081 extracts a high frequency component from pixel signals of a region used for focus detection out of all the pixel signals of the image sensor 106 as the output signals from the CDS/AGC/AD converter 107. A focus signal is generated using a luminance difference component or the like generated from the high frequency signal. The focus signal is also called a contrast evaluation value signal and represents the sharpness (contrast state) of an image generated based on the output signal from the image sensor 106. Since the sharpness changes depending on the focus state of the shooting optical system 120, the focus signal resultantly becomes a signal representing the focus state of the shooting optical system 120. The AF signal processing circuit 1081 is equivalent to a focus signal generating unit.

A display device 109 displays an image signal from the camera signal processing circuit 108. A recording device 110 records the image signal from the camera signal processing circuit 108 in a recording medium such as a magnetic tape, an optical disk, or a semiconductor memory. A camera microcomputer 111 controls a focus lens driving unit 113 (to be described later) based on an output from the camera signal processing circuit 108, and moves the focus lens 105 in the optical axis direction. This operation is mainly performed by an AF control unit 1111 arranged in the camera microcomputer 111. Details of the operation of the AF control unit 1111 will be described later. The AF control unit 1111 performs actual focus control in accordance with the decided target position of the focus lens 105. In addition, in scaling (zooming), the AF control unit 1111 performs zoom tracking control for moving the focus lens 105 based on zoom tracking data (zoom tracking cam) stored in advance. Accordingly, the imaging plane variation (blur) upon scaling can be prevented.

A zoom lens driving unit 112 moves the zoom lens 102 to perform scaling operation. The focus lens driving unit 113 moves the focus lens 105 to perform focus adjustment. Each of the zoom lens driving unit 112 and the focus lens driving unit 113 includes a drive source such as a stepping motor, a DC motor, a vibration motor, or a voice coil motor.

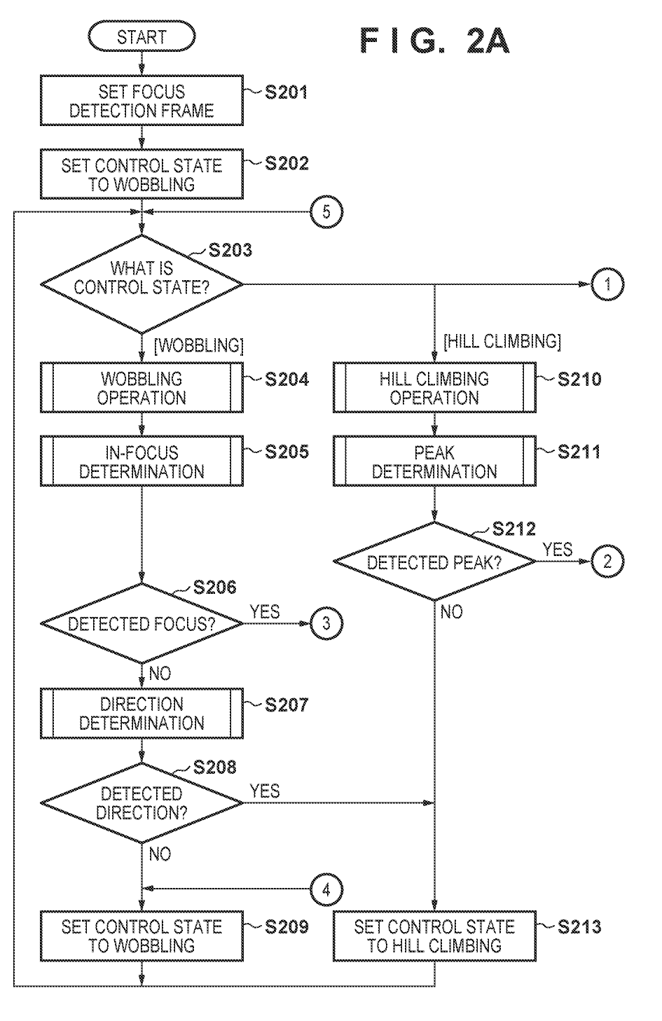

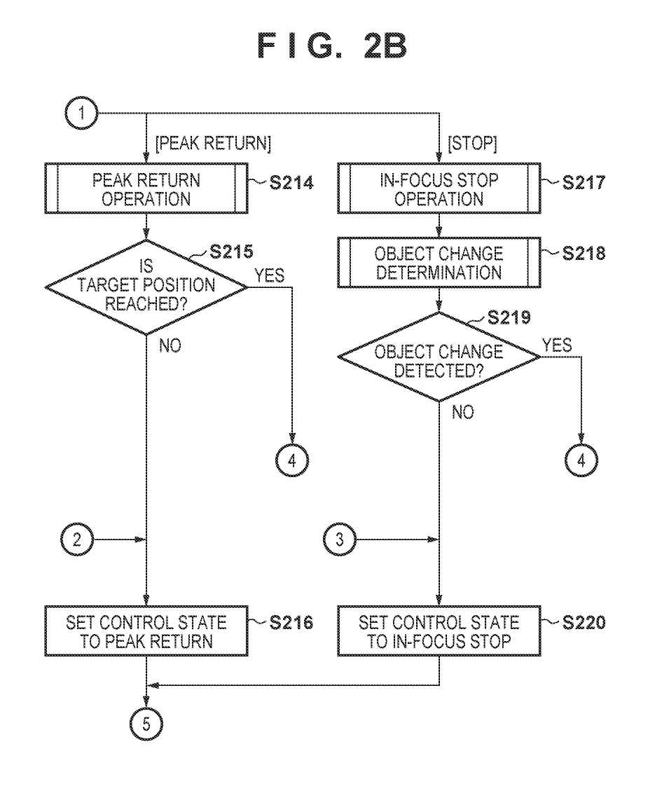

The outline of AF (Automatic Focus) control performed by the camera microcomputer 111 will be described with reference to FIGS. 2A to 4D.

FIGS. 2A and 2B are flowcharts showing the overall sequence of moving image AF control. This processing is mainly executed by the AF control unit 1111 in the camera microcomputer 111 in accordance with programs stored in a memory (not shown). This also applies to other embodiments to be described later.

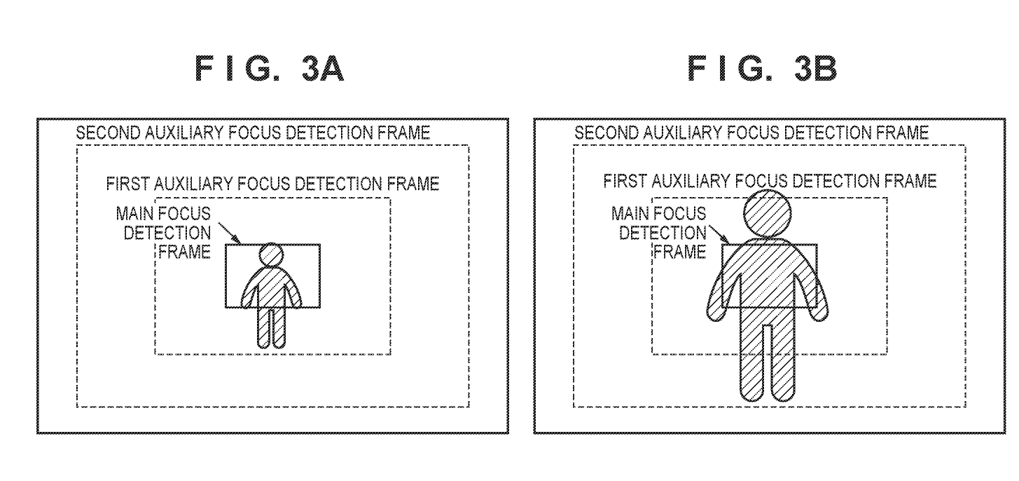

Referring to FIGS. 2A and 2B, in step S201, a focus detection frame (focus detection area) serving as an area for acquiring a focus signal by the AF signal processing circuit 1081 is set. In this embodiment, as shown in FIG. 3A, in addition to a main focus detection frame located at an object position, a first auxiliary focus detection frame including the main focus detection frame and larger than the main focus detection frame and a second auxiliary focus detection frame including the first auxiliary focus detection frame and larger than the first auxiliary focus detection frame are set. Note that although the focus detection frame is set, as shown in FIGS. 3A and 3B, the number, position, and size of the auxiliary focus detection frames may be arbitrary. Unless otherwise specified, a focus signal used in AF (Automatic Focusing) control is a focus signal obtained from the main focus detection frame.

In step S202, the AF control state is set to wobbling as an initial setting. In step S203, a current control state is determined. As a result of determination result, if the control state is a wobbling state, the process advances to step S204; if the control state is a hill climbing state, the process advances to step S210; if the control state is a peak return state, the process advances to step S214; and if the control state is a stop state, the process advances to step S217.

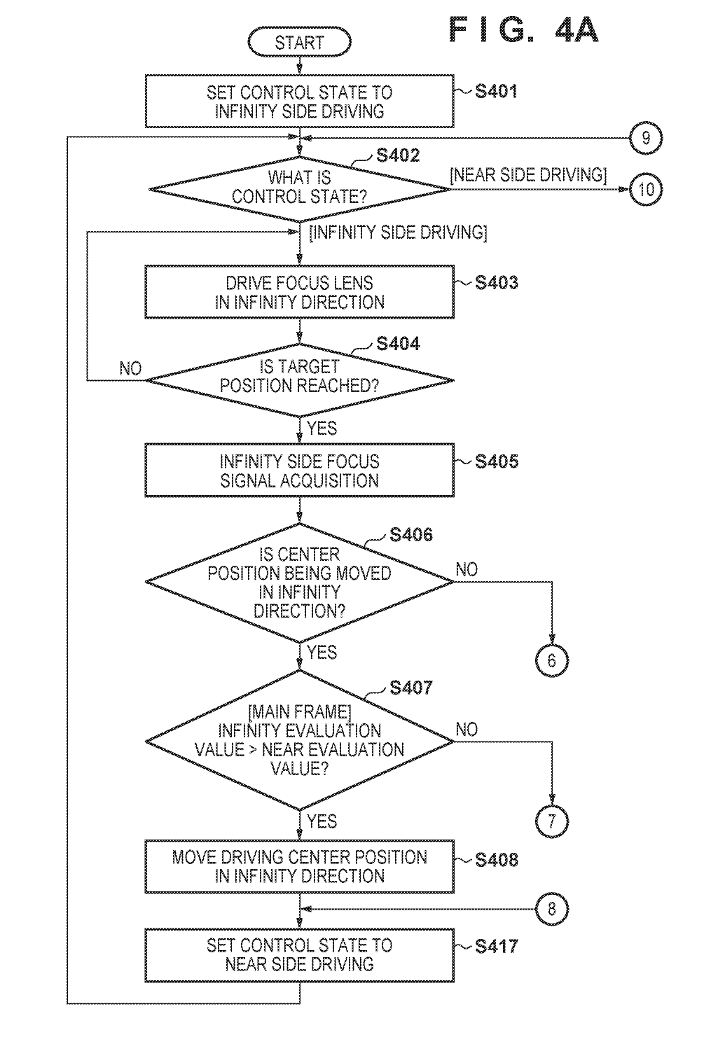

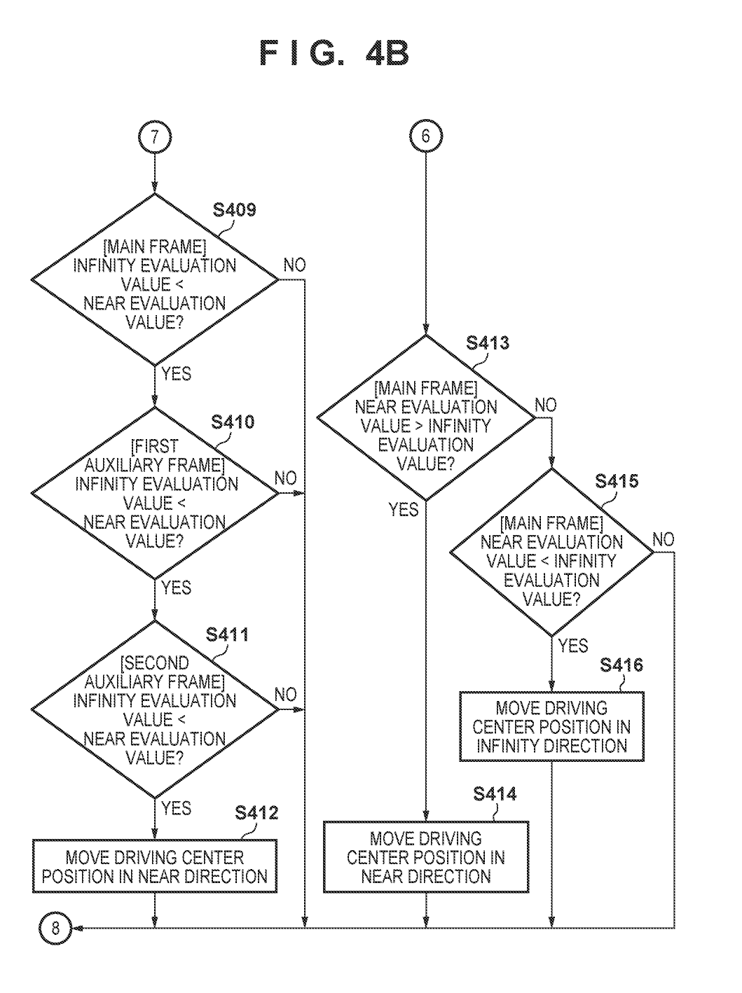

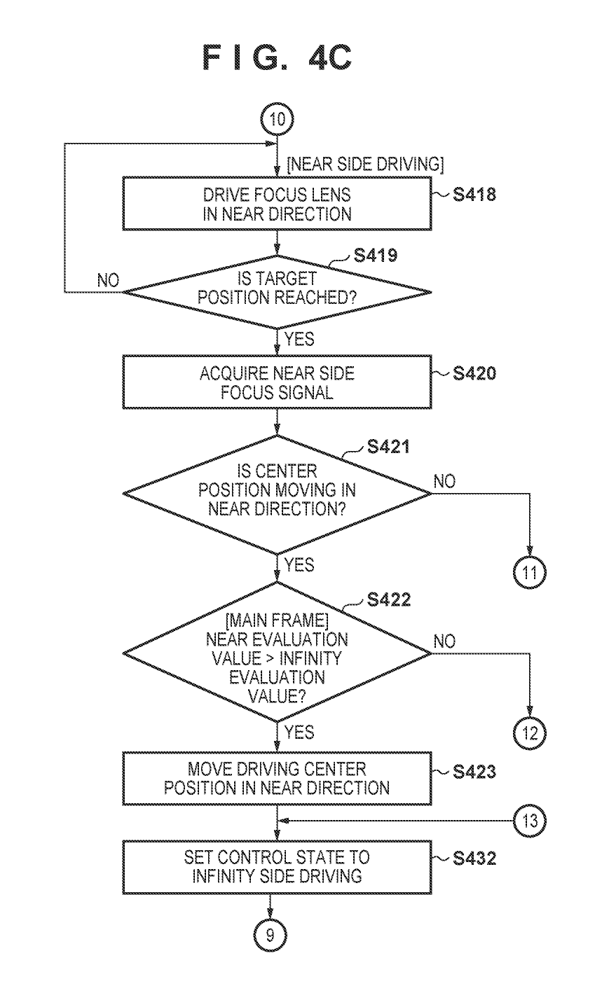

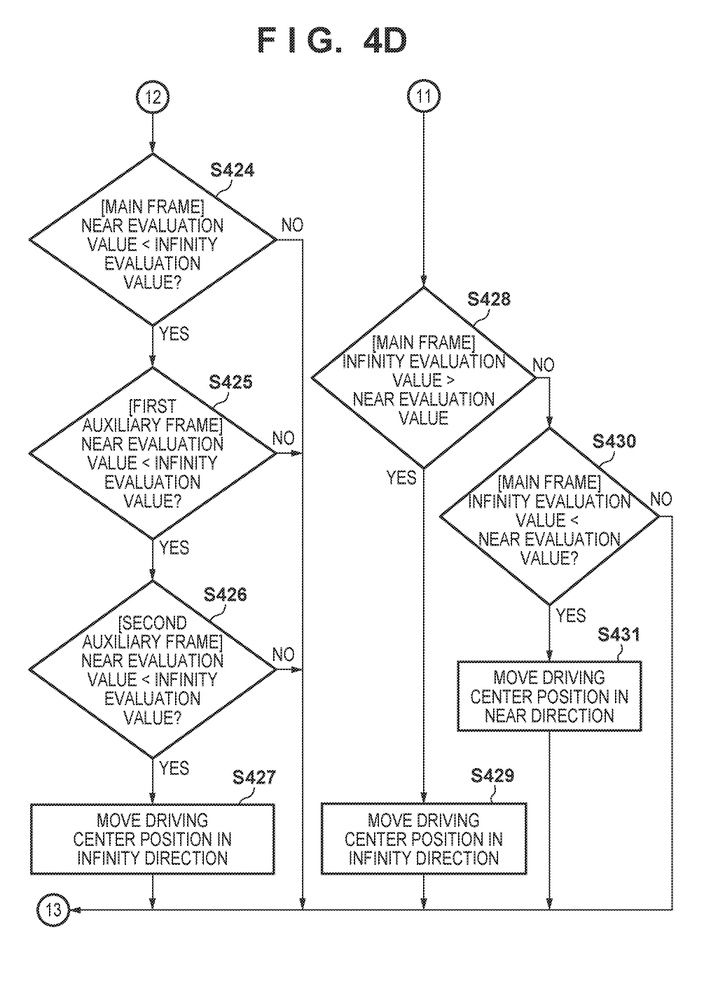

In step S204, a wobbling operation is performed based on the set driving amount parameters such that the focus lens 105 is continuously vibrated in the optical axis direction, and the vibration center position is moved in a direction for increasing the focus signal while confirming the magnitude relationship between the vibration destination near/infinity side focus signals. In this case, the driving amount parameters indicate the vibration of the focus lens 105 and the image capturing moving amount per cycle upon the center position movement. The parameters are normally set within the focal depth in consideration of the quality of the focusing process. However, basically, the parameters can be freely decided based on the target performance of the camera and the focus driving characteristic of a moving image compatible lens. Note that the wobbling operation will be described in detail later with reference to FIGS. 4A-4D.

In step S205, it is determined as a result of the wobbling operation in step S204 whether the state is an in-focus state. An example of determining the in-focus state is assumed such that the in-focus state is determined when the focus lens 105 reciprocates a single area a predetermined of times in accordance with the history of the positions of the focus lens 105.

If the in-focus state is determined in step S206 in accordance with the in-focus determination result in step S205, the process advances to step S220; otherwise, the process advances to step S207. It is determined in step S207 as a result of the wobbling operation in step S204 whether a direction in which an in-focus point exists is specified. An example of specifying the direction in which the in-focus point exists is assumed such that the direction in which the in-focus point exists can be specified by movement of the vibration center position in a single direction a predetermined number of times from the history of the positions of the focus lens 105. In addition, whether the object is a moving object can be determined in accordance with the movement of the vibration center position in a single direction continuously a predetermined number of times from the history of the positions of the focus lens 105.

If it is determined in step S208 as a result of direction determination in step S207 that the direction in which the in-focus point exists can be specified, the process advances to step S213; otherwise, the process advances to step S209. In step S209, the control state is set to wobbling.

In step S210, a hill climbing operation is performed such that based on the set driving speed parameter, the focus lens 105 is moved at a predetermined speed in the optical axis direction, and a position at which the focus signal becomes maximum is searched. In this case, the driving speed parameter indicates an imaging plane moving amount per unit time upon movement of the focus lens 105. The driving speed parameter is normally set within the focal depth in consideration of the quality of the focusing process. However, basically, the parameter can be freely decided based on the target performance of the camera and the focus driving characteristic of a moving image compatible lens. Note that since the hill climbing operation is a known technique, its detailed description will be omitted.

In step S211, it is determined as a result of the hill climbing operation in step S210 whether a peak at which the focus signal becomes maximum is detected. An example of detecting the peak is assumed such that the peak is detected by a decrease in the value of the focus signal by a predetermined value or more with respect to the maximum value. If it is determined in step S212 as a result of peak determination in step S211 that the peak at which the focus signal becomes maximum is detected, the process advances to step S216; otherwise, the process advances to step S213. In step S213, the control state is set to hill climbing.

In step S214, a peak return operation is performed such that the peak position detected in step S211 is set as a target position, and the focus lens 105 is moved at a predetermined speed. In step S215, it is determined whether the focus lens 105 reaches the target position set in step S214. If YES in step S214, the process advances to step S209; otherwise, the process advances to step S216. In step S216, the control state is set to peak return.

In step S217, an in-focus stop operation is performed such that the value of the focus signal obtained upon in-focus determination in step S205 is stored, and the focus lens 105 is stopped. In step S218, it is determined whether an object change as a trigger for restarting the AF control is detected. An example of detecting the object change is assumed such that the object change is detected by the change of the value of the current focus signal by a predetermined amount or more with respect to the value determined for the in-focus state in step S205.

If it is determined in step S219 as a result of object change determination in step S218 that the object change as the trigger for restarting the AF control is detected, the process advances to step S209; otherwise, the process advances to step S220. In step S220, the control state is set to in-focus stop. The above description has been made for the basic sequence of the moving image AF control.

Subsequently, details of the wobbling operation performed in step S204 will be described with reference to FIGS. 4A to 4D. Referring to FIGS. 4A to 4D, the control state of the wobbling control is set as infinity side driving as the initial setting in step S401.

In step S402, the current control state is determined. If the control state as a result of control state determination is infinity side driving, the process advances to step S403. However, if the control state is near side driving, the process advances to step S418.

In step S403, the focus lens 105 is driven in the infinity direction based on the set driving amount parameter. Note that since the driving amount is defined by a displacement amount from the driving center position, this driving amount is large if the driving center position is moved in the infinity direction in any one of steps S408, S416, S427, and S429 to be described later. To the contrary, if the driving center position is moved in the near direction in any one of steps S412, S414, S423, and S431 to be described later, the driving amount is small.

In step S404, it is determined whether the focus lens 105 reaches the target position set in step S403. If the focus lens 105 has reached the target position, the process advances to step S405; otherwise, the process returns to step S403. In step S405, an infinity side focus signal is acquired from an image signal generated by the image sensor 106 after the focus lens 105 has reached the target position set in step S403. Note that the focus signal at this time is acquired independently of the focus detection frames, that is, the main focus detection frame, the first auxiliary focus detection frame, and the second auxiliary focus detection frame set in step S201.

In step S406, it is determined whether the moving direction of the current driving center position is the infinity direction, that is, whether the driving center position is moving in the infinity direction in any one of steps S408, S416, S427, and S429 to be described later. If the current driving center position is moving in the infinity direction, the process advances to step S407; otherwise, the process advances to step S413. In step S407, the magnitude of the focus signal of the infinity side main focus detection frame obtained in step S405 is compared with that of the focus signal of the near side main focus detection frame obtained in step S420 to be described later. If the former magnitude is larger than the latter magnitude, the process advances to step S408; otherwise, the process advances to step S409.

In step S408, the driving center position of the wobbling operation is moved in the infinity direction based on the set driving amount parameter. Accordingly, the focus lens 105 can be moved gradually in the in-focus direction during the wobbling operation.

In step S409, the magnitude of the focus signal of the infinity side main focus detection frame obtained in step S405 is compared with that of the focus signal of the near side main focus detection frame obtained in step S420 to be described later. If the former magnitude is smaller than the latter magnitude, the process advances to step S410; otherwise, the process advances to step S417.

In step S410, the magnitude of the focus signal of the infinity side first auxiliary focus detection frame obtained in step S405 is compared with that of the focus signal of the near side first auxiliary focus detection frame obtained in step S420 to be described later. If the former magnitude is smaller than the latter magnitude, the process advances to step S411; otherwise, the process advances to step S417.

In step S411, the magnitude of the focus signal of the infinity side second auxiliary focus detection frame obtained in step S405 is compared with that of the focus signal of the near side second auxiliary focus detection frame obtained in step S420 to be described later. If the former magnitude is smaller than the latter magnitude, the process advances to step S412; otherwise, the process advances to step S417.

In step S412, the driving center position of the wobbling operation is moved in the near direction based on the set driving amount parameter. Accordingly, the focus lens 105 can be moved gradually in the in-focus direction during the wobbling operation.

More specifically, if the direction of increasing the focus signal of the main focus detection frame determined in step S407 matches the moving direction of the current driving center position determined in step S406, this direction is judged as the final in-focus direction, and the driving center position is immediately moved in step S408. On the other hand, if the above directions do not match due to the entry and exit of the object into and from the focus detection frame with the composition shown in FIG. 3B, the driving center position is not immediately moved. The position is judged as the final in-focus direction only if a frame has the same tendency as the first and second auxiliary focus detection frames which are relatively hardly influenced by the entry and exit of the object or the like. The driving center position is then moved in step S412. The focus tracking can be ensured even for a moving body.

In step S413, the magnitude of the focus signal of the infinity side main focus detection frame obtained in step S405 is compared with that of the focus signal of the near side main focus detection frame obtained in step S420 to be described later. If the former magnitude is smaller than the latter magnitude, the process advances to step S414; otherwise, the process advances to step S415. In step S414, the driving center position of the wobbling operation is moved in the near direction based on the set driving amount parameter.

In step S415, the magnitude of the focus signal of the infinity side main focus detection frame obtained in step S405 is compared with that of the focus signal of the near side main focus detection frame obtained in step S420 to be described later. If the former magnitude is larger than the latter magnitude, the process advances to step S416; otherwise, the process advances to step S417. In step S416, the driving center position of the wobbling operation is moved in the infinity direction based on the set driving amount parameter. In step S417, the control state is set to near side driving.

In step S418, the focus lens 105 is driven in the near direction based on the set driving amount parameter. Note that since the driving amount is defined by a displacement amount from the driving center position, this driving amount is large if the driving center position is moved in the near direction in any one of steps S412 and S414, and steps S423 and S431 to be described later. To the contrary, if the driving center position is moved in the infinity direction in any one of steps S408 and S416, and steps S427 and S429 to be described later, the driving amount is small.

In step S419, it is determined whether the focus lens 105 reaches the target position set in step S418. If the focus lens 105 has reached the target position, the process advances to step S420; otherwise, the process returns to step S418. In step S420, a near side focus signal is acquired from an image signal generated by the image sensor 106 after the focus lens 105 has reached the target position set in step S418. Note that the focus signal at this time is acquired independently of the focus detection frames, that is, the main focus detection frame, the first auxiliary focus detection frame, and the second auxiliary focus detection frame set in step S201.

In step S421, it is determined whether the moving direction of the current driving center position is the near direction, that is, whether the driving center position is moving in the near direction in any one of steps S412 and S414, and steps S423 and S431 to be described later. If the current driving center position is moving in the near direction, the process advances to step S422; otherwise, the process advances to step S428.

In step S422, the magnitude of the focus signal of the near side main focus detection frame obtained in step S420 is compared with that of the focus signal of the infinity side main focus detection frame obtained in step S405. If the former magnitude is larger than the latter magnitude, the process advances to step S423; otherwise, the process advances to step S424. In step S423, the driving center position of the wobbling operation is moved in the infinity direction as the final in-focus direction based on the set driving amount parameter. Accordingly, the focus lens 105 can be moved gradually in the in-focus direction during the wobbling operation.

In step S424, the magnitude of the focus signal of the near side main focus detection frame obtained in step S420 is compared with that of the focus signal of the infinity side main focus detection frame obtained in step S405. If the former magnitude is smaller than the latter magnitude, the process advances to step S425; otherwise, the process advances to step S432.

In step S425, the magnitude of the focus signal of the near side first auxiliary focus detection frame obtained in step S420 is compared with that of the focus signal of the infinity side first auxiliary focus detection frame obtained in step S405. If the former magnitude is smaller than the latter magnitude, the process advances to step S426; otherwise, the process advances to step S432.

In step S426, the magnitude of the focus signal of the near side second auxiliary focus detection frame obtained in step S420 is compared with that of the focus signal of the infinity side second auxiliary focus detection frame obtained in step S405. If the former magnitude is smaller than the latter magnitude, the process advances to step S427; otherwise, the process advances to step S432. In step S427, the driving center position of the wobbling operation is moved in the infinity direction as the final in-focus direction based on the set driving amount parameter. Accordingly, the focus lens 105 can be moved gradually in the in-focus direction during the wobbling operation.

More specifically, if the direction of increasing the focus signal of the main focus detection frame determined in step S422 matches the moving direction of the current driving center position determined in step S421, the driving center position is immediately moved in step S423. On the other hand, if the above directions do not match due to the entry and exit of the object into and from the focus detection frame with the composition shown in FIG. 3B, the driving center position is not immediately moved. The driving center position is moved in step S427 only if a frame has the same tendency as the first and second auxiliary focus detection frames which are relatively hardly influenced by the entry and exit of the object or the like. The focus tracking can be ensured even for a moving body.

In step S428, the magnitude of the focus signal of the near side main focus detection frame obtained in step S420 is compared with that of the focus signal of the infinity side main focus detection frame obtained in step S405. If the former magnitude is smaller than the latter magnitude, the process advances to step S429; otherwise, the process advances to step S430. In step S429, the driving center position of the wobbling operation is moved in the infinity direction based on the set driving amount parameter.

In step S430, the magnitude of the focus signal of the near side main focus detection frame obtained in step S420 is compared with that of the focus signal of the infinity side main focus detection frame obtained in step S405. If the former magnitude is larger than the latter magnitude, the process advances to step S431; otherwise, the process advances to step S432. In step S431, the driving center position of the wobbling operation is moved in the near direction based on the set driving amount parameter. In step S432, the control state is set in to infinity side driving.

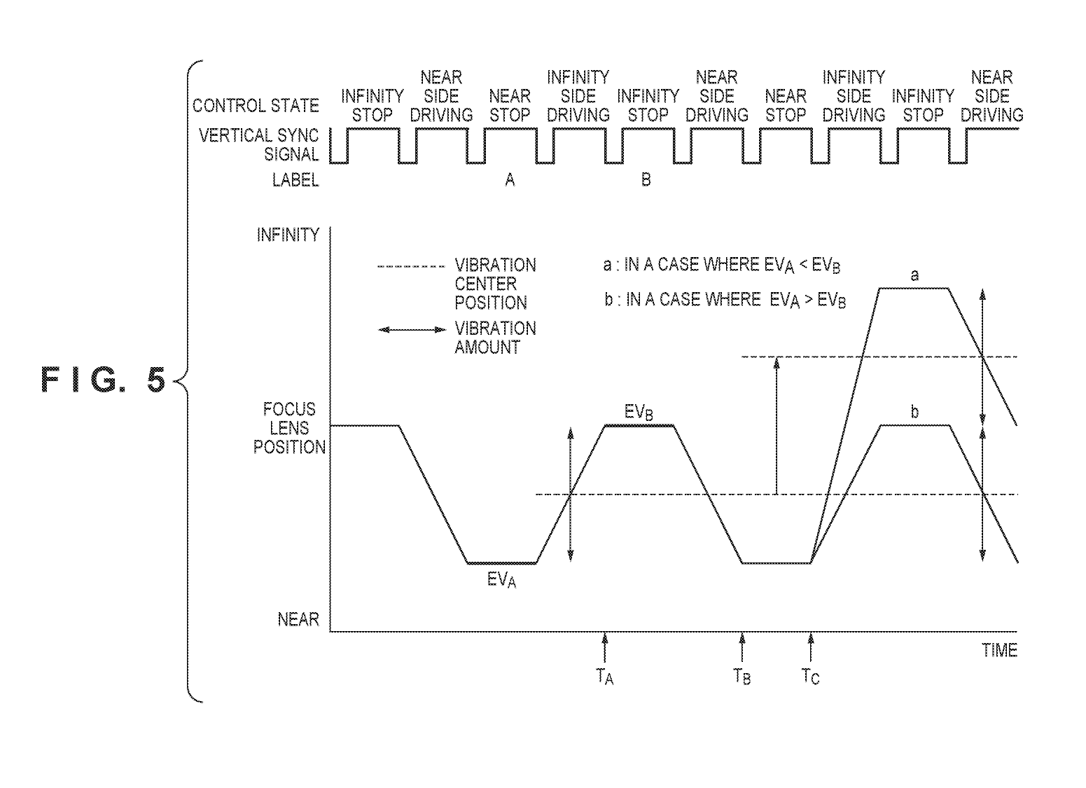

A change in time of the position of the focusing lens 105 in this wobbling operation is shown in FIG. 5. The upper side of FIG. 5 represents the vertical sync signal of an image signal. In the lower side of FIG. 5, the abscissa represents the time, and the ordinate represents the position of the focus lens 105. The AF control unit 1111 in the camera microcomputer 111 receives, at time TA, a focus signal EVA corresponding to the charges accumulated in the image sensor 106 at time A. Similarly, the AF control unit 1111 in the camera microcomputer 111 receives, at time TB, a focus signal EVB corresponding to the charges accumulated in the image sensor 106 at time B. At time TC, the focus signals EVA and EVB are compared with each other. Only if EVB in FIG. 5 is larger than EVA, the vibration center position is moved.

As described above, by controlling focus lens 105 while the wobbling, hill climbing, peak return, and in-focus stop operations are repeated so that the focus signal is always maximum in the moving image AF control performed by the AF control unit 1111 in the camera microcomputer 111, the in-focus state can be maintained. In particular, in the wobbling operation, by appropriately selecting the focus detection frame of the focus signal used in direction determination in accordance with the state of the moving direction of the driving center, focus tracking can be reliably performed even for the moving object.

As has been described above, according to this embodiment, the AF operation smoothly tracking even the moving object can be provided.

Note that the first embodiment described above exemplifies a case in which in addition to the main focus detection frame, the first auxiliary focus detection frame including the main focus detection frame and larger than the main focus detection frame and the second auxiliary detection frame including the first auxiliary focus detection frame and larger than the first auxiliary focus detection frame are set. However, the direction of moving the wobbling moving center may be determined using only the main focus detection frame and the first auxiliary focus detection frame including the main focus detection frame and larger than the main focus detection frame. In this case, steps S411 and S426 in FIGS. 4B-4D are skipped.

### Second Embodiment

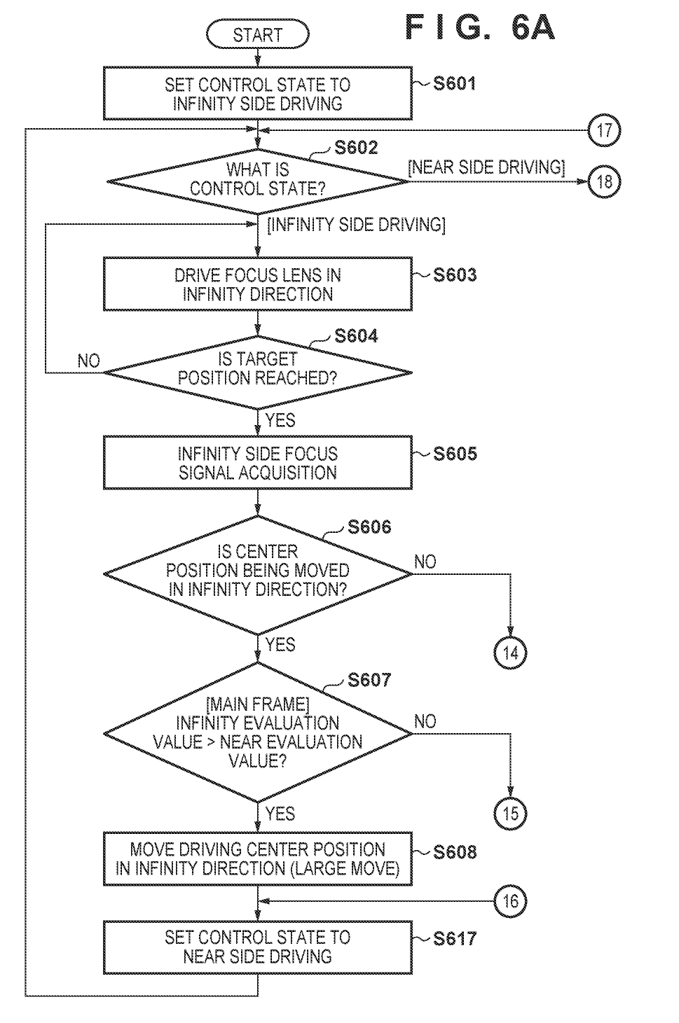

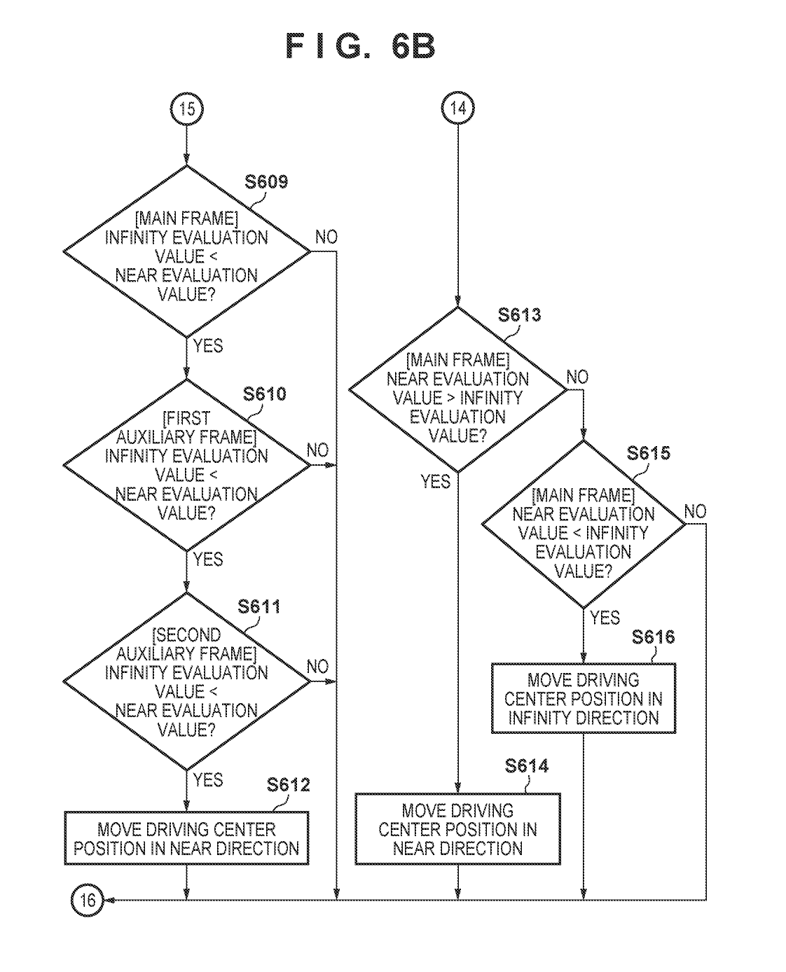

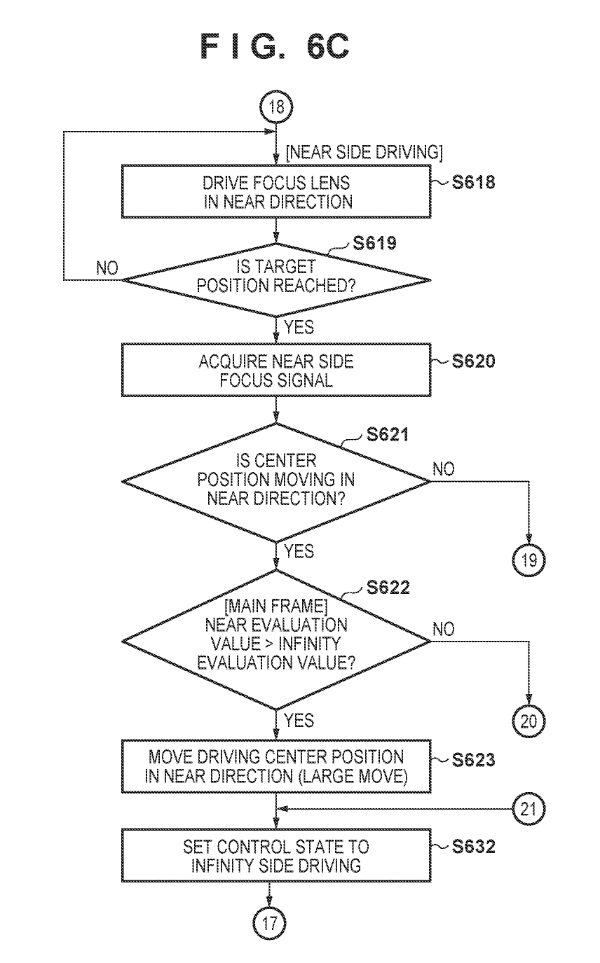

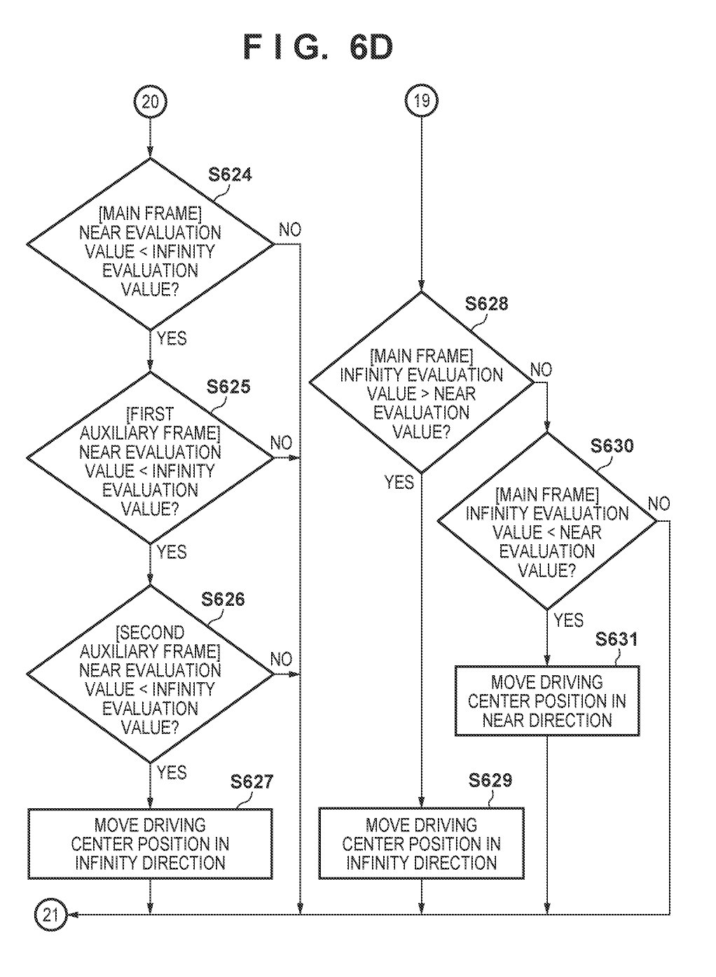

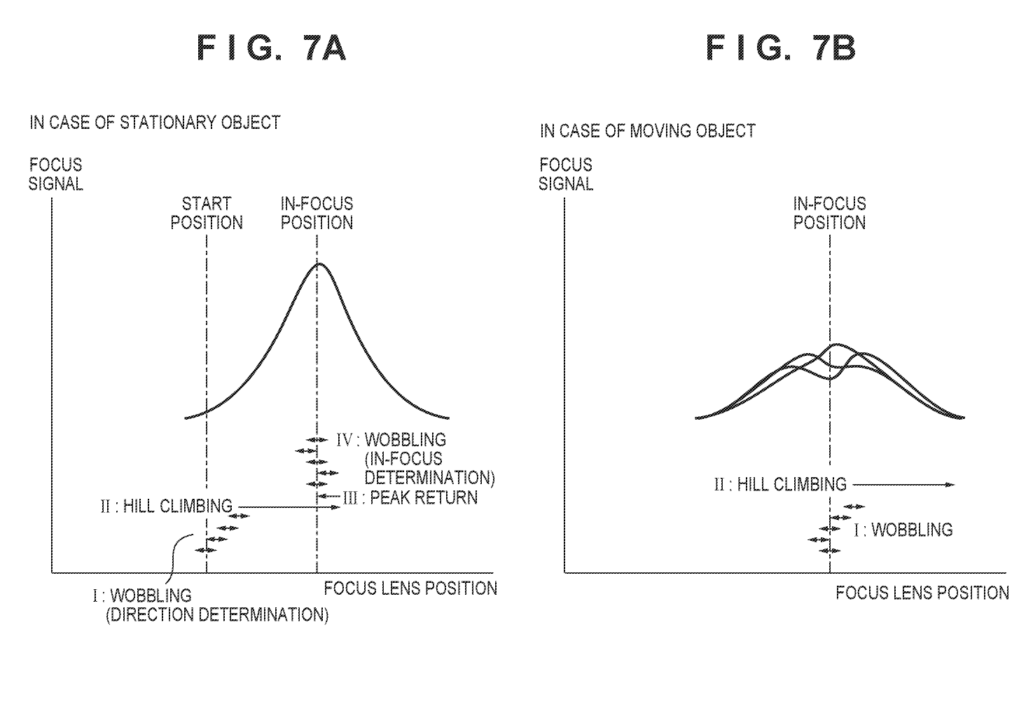

The second embodiment of the present invention will now be described below. In the first embodiment, the condition of moving the driving center of the wobbling operation is switched in accordance with the focus detection frames. In the second embodiment, switching can also be made for the moving amount of the driving center. The arrangement of the image capturing apparatus and the flowchart of the moving image AF control are the same as in FIGS. 1, 2A and 2B of the first embodiment. FIGS. 6A to 6D is a detailed flowchart of the wobbling operation of step S204 in the second embodiment.

Referring to FIGS. 6A to 6D, the control state of the wobbling control is set as infinity side driving as the initial setting in step S601.

In step S602, the current control state is determined. If the control state as a result of control state determination is infinity side driving, the process advances to step S603. However, if the control state is near side driving, the process advances to step S618.

In step S603, the focus lens 105 is driven in the infinity direction based on the set driving amount parameter. Note that since the driving amount is defined by a displacement amount from the driving center position, this driving amount is large if the driving center position is moved in the infinity direction in any one of steps S608, S616, S627, and S629 to be described later. To the contrary, if the driving center position is moved in the near direction in any one of steps S612, S614, S623, and S631 to be described later, the driving amount is small.

In step S604, it is determined whether a focus lens 105 reaches the target position set in step S603. If the focus lens 105 has reached the target position, the process advances to step S605; otherwise, the process returns to step S603. In step S605, an infinity side focus signal is acquired from an image signal generated by an image sensor 106 after the focus lens 105 has reached the target position set in step S603. Note that the focus signal at this time is acquired independently of the focus detection frames, that is, the main focus detection frame, the first auxiliary focus detection frame, and the second auxiliary focus detection frame set in step S201.

In step S606, it is determined whether the moving direction of the current driving center position is the infinity direction, that is, whether the driving center position is moving in the infinity direction in any one of steps S608, S616, S627, and S629 to be described later. If the current driving center position is moving in the infinity direction, the process advances to step S607; otherwise, the process advances to step S613. In step S607, the magnitude of the focus signal of the infinity side main focus detection frame obtained in step S605 is compared with that of the focus signal of the near side main focus detection frame obtained in step S620 to be described later. If the former magnitude is larger than the latter magnitude, the process advances to step S608; otherwise, the process advances to step S609.

In step S608, the driving center position of the wobbling operation is moved in the infinity direction based on the set driving amount parameter. In the second embodiment, the driving amount parameter is set larger than that in the normal operation, trackability can be improved for the moving object. Accordingly, the focus lens 105 can be moved gradually in the in-focus direction during the wobbling operation.

In step S609, the magnitude of the focus signal of the infinity side main focus detection frame obtained in step S605 is compared with that of the focus signal of the near side main focus detection frame obtained in step S620 to be described later. If the former magnitude is smaller than the latter magnitude, the process advances to step S610; otherwise, the process advances to step S617.

In step S610, the magnitude of the focus signal of the infinity side first auxiliary focus detection frame obtained in step S605 is compared with that of the focus signal of the near side first auxiliary focus detection frame obtained in step S620 to be described later. If the former magnitude is smaller than the latter magnitude, the process advances to step S611; otherwise, the process advances to step S617.

In step S611, the magnitude of the focus signal of the infinity side second auxiliary focus detection frame obtained in step S605 is compared with that of the focus signal of the near side second auxiliary focus detection frame obtained in step S620 to be described later. If the former magnitude is smaller than the latter magnitude, the process advances to step S612; otherwise, the process advances to step S617.

In step S612, the driving center position of the wobbling operation is moved in the near direction based on the set driving amount parameter. Accordingly, the focus lens 105 can be moved gradually in the in-focus direction during the wobbling operation.

More specifically, if the direction of increasing the focus signal of the main focus detection frame determined in step S607 matches the moving direction of the current driving center position determined in step S606, the driving center position is more positively moved. On the other hand, if the above directions do not match due to the entry and exit of the object into and from the focus detection frame with the composition shown in FIG. 3B, the driving center position is not immediately moved. The driving center position is moved in step S612 only if a frame has the same tendency as the first and second auxiliary focus detection frames which are relatively hardly influenced by the entry and exit of the object or the like. The focus tracking can be ensured even for a moving body.

In step S613, the magnitude of the focus signal of the infinity side main focus detection frame obtained in step S605 is compared with that of the focus signal of the near side main focus detection frame obtained in step S620 to be described later. If the former magnitude is smaller than the latter magnitude, the process advances to step S614; otherwise, the process advances to step S615. In step S614, the driving center position of the wobbling operation is moved in the near direction based on the set driving amount parameter.

In step S615, the magnitude of the focus signal of the infinity side main focus detection frame obtained in step S605 is compared with that of the focus signal of the near side main focus detection frame obtained in step S620 to be described later. If the former magnitude is larger than the latter magnitude, the process advances to step S616; otherwise, the process advances to step S617. In step S616, the driving center position of the wobbling operation is moved in the infinity direction based on the set driving amount parameter. In step S617, the control state is set to near side driving.

In step S618, the focus lens 105 is driven in the near direction based on the set driving amount parameter. Note that since the driving amount is defined by a displacement amount from the driving center position, this driving amount is large if the driving center position is moved in the near direction in any one of steps S612 and S614, and steps S623 and S631 to be described later. To the contrary, if the driving center position is moved in the infinity direction in any one of steps S608 and S616, and steps S627 and S629 to be described later, the driving amount is small.

In step S619, it is determined whether the focus lens 105 reaches the target position set in step S618. If the focus lens 105 has reached the target position, the process advances to step S620; otherwise, the process returns to step S618. In step S620, a near side focus signal is acquired from an image signal generated by the image sensor 106 after the focus lens 105 has reached the target position set in step S618. Note that the focus signal at this time is acquired independently of the focus detection frames, that is, the main focus detection frame, the first auxiliary focus detection frame, and the second auxiliary focus detection frame set in step S201.

In step S621, it is determined whether the moving direction of the current driving center position is the near direction, that is, whether the driving center position is moving in the near direction in any one of steps S612 and S614, and steps S623 and S631 to be described later. If the current driving center position is moving in the near direction, the process advances to step S622; otherwise, the process advances to step S628.

In step S622, the magnitude of the focus signal of the near side main focus detection frame obtained in step S620 is compared with that of the focus signal of the infinity side main focus detection frame obtained in step S605. If the former magnitude is larger than the latter magnitude, the process advances to step S623; otherwise, the process advances to step S624. In step S623, the driving center position of the wobbling operation is moved in the near direction based on the set driving amount parameter. In the second embodiment, the driving amount parameter is set larger than that in the normal operation, trackability can be improved for the moving object. Accordingly, the focus lens 105 can be moved gradually in the in-focus direction during the wobbling operation.

In step S624, the magnitude of the focus signal of the near side main focus detection frame obtained in step S620 is compared with that of the focus signal of the infinity side main focus detection frame obtained in step S605. If the former magnitude is smaller than the latter magnitude, the process advances to step S625; otherwise, the process advances to step S632.

In step S625, the magnitude of the focus signal of the near side first auxiliary focus detection frame obtained in step S620 is compared with that of the focus signal of the infinity side first auxiliary focus detection frame obtained in step S605. If the former magnitude is smaller than the latter magnitude, the process advances to step S626; otherwise, the process advances to step S632.

In step S626, the magnitude of the focus signal of the near side second auxiliary focus detection frame obtained in step S620 is compared with that of the focus signal of the infinity side second auxiliary focus detection frame obtained in step S605. If the former magnitude is smaller than the latter magnitude, the process advances to step S627; otherwise, the process advances to step S632. In step S627, the driving center position of the wobbling operation is moved in the infinity direction based on the set driving amount parameter. Accordingly, the focus lens 105 can be moved gradually in the in-focus direction during the wobbling operation.

More specifically, if the direction of increasing the focus signal of the main focus detection frame determined in step S622 matches the moving direction of the current driving center position determined in step S621, the driving center position is more positively moved. On the other hand, if the above directions do not match due to the entry and exit of the object into and from the focus detection frame with the composition shown in FIG. 3B, the driving center position is not immediately moved. The driving center position is moved in step S627 only if a frame has the same tendency as the first and second auxiliary focus detection frames which are relatively hardly influenced by the entry and exit of the object or the like. The focus tracking can be ensured even for a moving body.

In step S628, the magnitude of the focus signal of the near side main focus detection frame obtained in step S620 is compared with that of the focus signal of the infinity side main focus detection frame obtained in step S605. If the former magnitude is smaller than the latter magnitude, the process advances to step S629; otherwise, the process advances to step S630. In step S629, the driving center position of the wobbling operation is moved in the infinity direction based on the set driving amount parameter.

In step S630, the magnitude of the focus signal of the near side main focus detection frame obtained in step S620 is compared with that of the focus signal of the infinity side main focus detection frame obtained in step S605. If the former magnitude is larger than the latter magnitude, the process advances to step S631; otherwise, the process advances to step S632. In step S631, the driving center position of the wobbling operation is moved in the near direction based on the set driving amount parameter. In step S632, the control state is set to the infinity side driving. The rest of the processing in the second embodiment is the same as in the first embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-242230, filed Dec. 18, 2017, which is hereby incorporated by reference herein in its entirety.

What is claimed is:

1. An image capturing apparatus comprising:
an image sensor configured to capture an object image;
a determination unit configured to determine an in-focus direction as a direction of moving a focus lens to focus on the object image based on a magnitude relationship between focus signals obtained from the image sensor when the focus lens for adjusting a focal point undergoes wobbling along an optical axis;
a control unit configured to perform focus adjustment by moving a wobbling center position of the focus lens in the in-focus direction; and
an acquisition unit configured to acquire a first focus signal serving as the focus signal obtained from a first focus detection area of the image sensor and a second focus signal serving as the focus signal obtained from a second focus detection area including the first focus detection area and larger than the first focus detection area,
wherein the control unit judges a final in-focus direction based on a first in-focus direction if a first moving direction serving as a direction of moving the current wobbling center position of the focus lens matches the first in-focus direction serving as the in-focus direction determined by the determination unit based on the first focus signal, and judges the final in-focus direction based on the first in-focus direction and a second in-focus direction serving as the in-focus direction determined by the determination unit based on the second in-focus signal if the first moving direction does not match the first in-focus direction.

2. The apparatus according to claim 1, wherein if the first moving direction matches the first in-focus direction, the control unit judges the first in-focus direction as the final in-focus direction.

3. The apparatus according to claim 1, wherein if the first moving direction matches the first in-focus direction, the control unit judges the first in-focus direction as the final in-focus direction and increases a moving amount of the wobbling center position of the focus lens.

4. The apparatus according to claim 1, wherein if the first moving direction does not match the first in-focus direction and the first in-focus direction matches the second in-focus direction, the control unit judges the matching first in-focus direction and second in-focus direction as the final in-focus direction.

5. The apparatus according to claim 1, wherein the acquisition unit further acquires a third focus signal serving as the focus signal obtained from a third focus detection area including the second focus detection area and larger than the second focus detection area.

6. The apparatus according to claim 5, wherein if the first moving direction does not match the first in-focus direction, the control unit judges the final in-focus direction based on the first in-focus direction, the second in-focus direction, and the third in-focus direction serving as the in-focus direction determined by the determination unit based on the third focus signal.

7. The apparatus according to claim 6, wherein if the first moving direction does not match the first in-focus direction and the first in-focus direction, second in-focus direction, and the third in-focus direction match each other, the control unit judges the matching first in-focus direction, second in-focus direction, and third in-focus direction as the final in-focus direction.

8. The apparatus according to claim 1, wherein the control unit judges based on a history of a moving direction of the wobbling center position along an optical axis of the focus lens whether an object is moving.

9. The apparatus according to claim 8, wherein if the wobbling center position along the optical axis of the focus lens is moved continuously in the same direction, the control unit judges that the object is moving.

10. The apparatus according to claim 8, wherein if the control unit judges that the object is not moved, the control unit judges the first in-focus direction as the final in-focus direction.

11. A method of controlling an image capturing apparatus including an image sensor configured to capture an object image, the method comprising:
determining an in-focus direction as a direction of moving a focus lens to focus on the object image based on a magnitude relationship between focus signals obtained from the image sensor when the focus lens for adjusting a focal point undergoes wobbling along an optical axis;
controlling to perform focus adjustment by moving a wobbling center position of the focus lens in the in-focus direction; and
acquiring a first focus signal serving as the focus signal obtained from a first focus detection area of the image sensor and a second focus signal serving as the focus signal obtained from a second focus detection area including the first focus detection area and larger than the first focus detection area,
wherein in the controlling, a final in-focus direction is judged based on a first in-focus direction if a first moving direction serving as a direction of moving the current wobbling center position of the focus lens matches the first in-focus direction serving as the determined in-focus direction based on the first focus signal, and the final in-focus direction is judged based on the first in-focus direction and a second in-focus direction serving as the in-focus direction determined by the determination unit based on the second in-focus signal if the first moving direction does not match the first in-focus direction.

12. A non-transitory computer-readable medium storing a program for causing a computer to execute each step of a method of controlling an image capturing apparatus including an image sensor configured to capture an object image, the method comprising:
determining an in-focus direction as a direction of moving a focus lens to focus on the object image based on a magnitude relationship between focus signals obtained from the image sensor when the focus lens for adjusting a focal point undergoes wobbling along an optical axis;
controlling to perform focus adjustment by moving a wobbling center position of the focus lens in the in-focus direction; and
acquiring a first focus signal serving as the focus signal obtained from a first focus detection area of the image sensor and a second focus signal serving as the focus signal obtained from a second focus detection area including the first focus detection area and larger than the first focus detection area,
wherein in the controlling, a final in-focus direction is judged based on a first in-focus direction if a first moving direction serving as a direction of moving the current wobbling center position of the focus lens matches the first in-focus direction serving as the determined in-focus direction based on the first focus signal, and the final in-focus direction is judged based on the first in-focus direction and a second in-focus direction serving as the in-focus direction determined by the determination unit based on the second in-focus signal if the first moving direction does not match the first in-focus direction.
